(19) United States
(12) Patent Application Publication
(10) Pub. No.: US 2026/0181477 A1
(43) Pub. Date: Jun. 25, 2026

(54) METHOD AND DEVICE FOR INFORMATION TRANSMISSION

(71) Applicant: SAMSUNG ELECTRONICS CO., LTD., Suwon-si, Gyeonggi-do (KR)

(72) Inventors: Xingyu HAN, Beijing (CN); Weiwei WANG, Beijing (CN)

(21) Appl. No.: 19/101,545

(22) PCT Filed: Aug. 4, 2023
(86) PCT No.: PCT/KR2023/011473

§ 371 Date: Feb. 5, 2025

(30) Foreign Application Priority Data
Aug. 5, 2022 (CN) 202210938938.2
Jun. 26, 2023 (CN) 202310762723.4

(51) Int. Cl. H04W 28/06

(52) U.S. Cl. CPC H04W 28/06

(57) ABSTRACT

The invention provides a method and apparatus for information transmission. The method comprising: transmitting a first message to a user plane part of the central unit; and receiving a response message to the first message from the user plane part of the central unit; wherein the first message includes an indication information, and wherein the fourth indication information includes at least one of: related indication for path switch, related indication to keep buffering, related indication to stop discarding data, or related indication to stop transmitting downlink data delivery status information.

### TECHNICAL FIELD

The invention relates to wireless communication technology, in particular to an information transmission method and equipment.

### BACKGROUND ART

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service. Currently, there are ongoing discussions regarding improvement and performance [3] enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem

The present disclosure relates to wireless communication systems and, more specifically, the invention relates to wireless communication technology, in particular to an information transmission method and equipment.

### Solution to Problem

According to various embodiments of the invention, a method performed by a sixth node is provided, including: transmitting an eleventh message to a seventh node, and receiving a response message to the eleventh message from the seventh node, wherein the eleventh message includes fourth indication information, and wherein the fourth indication information includes at least one of: related indication for path switch, related indication to maintain/keep caching/buffering, related indication to stop discarding data, or related indication to stop transmitting downlink data delivery status information.

According to an implementation of the invention, the eleventh message includes a bearer context modification request message and the response message to the eleventh message includes a bearer context modification response message.

According to an implementation of the invention, the method further includes: triggering/initiating a procedure of a first interface or triggering/initiating a message of the first interface to trigger/initiate the transmitting/sending of the eleventh message.

According to an implementation of the invention, the eleventh message is used to indicate the seventh node to perform at least one of: maintaining/keeping caching/buffering downlink data, stopping discarding the downlink data, maintaining/keeping caching/buffering the downlink data even if the downlink data delivery status information indicates that the downlink data has been successfully delivered, and stopping discarding the downlink data even if the downlink data delivery status information indicates that the downlink data has been successfully delivered.

According to various embodiments of the invention, a method performed by a seventh node is provided, including: receiving an eleventh message from a sixth node, and transmitting/sending a response message to the eleventh message to the sixth node, wherein the eleventh message includes fourth indication information, and wherein the fourth indication information includes at least one of: related indication for path switch, related indication to maintain/keep caching/buffering, related indication to stop discarding data, or related indication to stop transmitting/sending downlink data delivery status information.

According to an implementation of the invention, the eleventh message includes a bearer context modification request message and the response message to the eleventh message includes a bearer context modification response message.

According to an implementation of the invention, the receiving of the eleventh message is triggered/initiated by the sixth node by triggering/initiating a procedure of a first interface or a message of the first interface.

According to an implementation of the invention, the method further includes according to the eleventh message, performing at least one of: maintaining/keeping caching/buffering downlink data, stopping discarding the downlink data, maintaining/keeping caching/buffering the downlink data even if the downlink data delivery status information indicates that the downlink data has been successfully delivered, and stopping discarding the downlink data even if the downlink data delivery status information indicates that the downlink data has been successfully delivered.

According to various embodiments of the invention, a method performed by a sixth node is provided, including: triggering/initiating a procedure of a second interface or triggering/initiating a message of the second interface; and transmitting/sending a twelfth message to a third node, wherein the twelfth message is used to indicate the third node to stop transmitting/sending downlink data delivery status information.

According to an implementation of the invention, the twelfth message includes fifth indication information, and the fifth indication information includes at least one of: related indication for path switch, related indication to maintain/keep caching/buffering, related indication to stop discarding data, and related indication to stop transmitting/sending the downlink data delivery status information.

According to an implementation of the invention, the twelfth message includes a user equipment UE context modification request message or a second interface message different from the UE context modification request message.

According to an implementation of the invention, the method further includes at least one of: receiving a UE context modification response message or a UE context modification failure message from the third node if the twelfth message includes the UE context modification request message; receiving a response message or an acknowledgement message or a failure message or a rejection message to the second interface message from the third node if the twelfth message includes the second interface message; and not receiving a message in response to the twelfth message from the third node.

According to various embodiments of the invention, a method performed by a third node is provided, including: receiving a twelfth message from a sixth node; and stop transmitting/sending downlink data delivery status information according to the twelfth message.

According to an implementation of the invention, the twelfth message includes fifth indication information, and the fifth indication information includes at least one of: related indication for path switch, related indication to maintain/keep caching/buffering, related indication to stop discarding data, and related indication to stop transmitting/sending the downlink data delivery status information.

According to an implementation of the invention, the twelfth message includes a user equipment UE context modification request message or a second interface message different from the UE context modification request message.

According to an implementation of the invention, the method further includes at least one of: transmitting/sending a UE context modification response message or a UE context modification failure message to the sixth node if the twelfth message includes the UE context modification request message; transmitting/sending a response message or an acknowledgement message or a failure message or a rejection message to the second interface message to the sixth node if the twelfth message includes the second interface message; not responding to the twelfth message; and not transmitting/sending a message in response to the twelfth message to the sixth node.

According to various embodiments of the invention, an information transmission method performed by a second node is provided, including: receiving a first message from a first node, wherein the first message includes first related information of candidate relay UEs or relay UEs; and transmitting a second message in response to the first message to the first node based on the first related information of the candidate relay UEs or relay UEs.

According to an implementation of the invention, the first related information of the candidate relay UEs or relay UEs includes at least one of the following information: a first information requesting or indicating path switch, a first information requesting or indicating conditional path switch, a first list of the candidate relay UEs or relay UEs, a first identification information of the candidate relay UEs or relay UEs, a first cell identity information for the candidate relay UEs or relay UEs, a measurement report for sidelink measurement results between the candidate relay UEs or relay UEs and a remote UE, and a first identification information of the remote UE.

According to an implementation of the invention, the first information requesting or indicating conditional path switch includes at least one of the following information: a first conditional path switch request indication, a first conditional path switch initiation indication, a first conditional path switch replace indication, a first estimated arrival probability, and a target NG-RAN (next generation radio access network) node UE (user equipment) XnAP (Xn application protocol) ID.

According to an implementation of the invention, the second message includes second related information of candidate relay UEs or relay UEs, and the second related information of the candidate relay UEs or relay UEs includes at least one of the following information: a first indication information for responding to or acknowledging of or confirming on providing a path switch configuration, a first indication information for responding to or acknowledging of or confirming on providing a conditional path switch configuration, a first number/maximum number of conditional path switch preparations, a second list of the candidate relay UEs or relay UEs, a second identification information of the candidate relay UEs or relay UEs, a second cell identity information for the candidate relay UEs or relay UEs, a first configuration information for the remote UE, and a second identification information of the remote UE.

According to an implementation of the invention, the second list of the candidate relay UEs or relay UEs is a subset of the first list of the candidate relay UEs or relay UEs.

According to an implementation of the invention, the first configuration information for the remote UE includes at least one of the following information: a first configuration information or addition/setup information or modification information of a PC5 radio link control RLC channel, a first configuration information or addition/setup information or modification information of a radio bearer, and a first configuration information or addition/setup information or modification information of a Sidelink Relay Adaptation Protocol SRAP.

According to an implementation of the invention, the second identification information of the remote UE includes at least one of the following information: a local ID of the remote UE, and a Layer-2 ID of the remote UE.

According to an implementation of the invention, the method further includes: transmitting a fourth message to a third node, wherein the fourth message includes fourth related information of candidate relay UEs or relay UEs; and receiving a fifth message in response to the fourth message from the third node, wherein the fifth message includes fifth related information of candidate relay UEs or relay UEs.

According to an implementation of the invention, the fourth related information of the candidate relay UEs or relay UEs includes at least one of the following information: a third information requesting or indicating path switch, a third information requesting or indicating conditional path switch, a fourth list of the candidate relay UEs or relay UEs, a fourth identification information of the candidate relay UEs or relay UEs, a fourth cell identity information for the candidate relay UEs or relay UEs, and a third configuration information for a remote UE.

According to an implementation of the invention, the third information requesting or indicating conditional path switch includes at least one of the following information: a second conditional path switch request indication, a second conditional path switch initiation indication, a second conditional path switch replace indication, a first conditional path switch cancel indication, a second estimated arrival probability, a target gNB-DU (distributed unit) UE (user equipment) F1AP (F1 application protocol) ID, and an identification information of the candidate relay UEs or relay UEs and/or an identification information of cells to be cancelled.

According to an implementation of the invention, the fifth related information of the candidate relay UEs or relay UEs includes at least one of the following information: a second indication information for responding to or acknowledging of or confirming on providing a path switch configuration, a second indication information for responding to or acknowledging of or confirming on providing a conditional path switch configuration, a second number/maximum number of conditional path switch preparations, a fifth list of the candidate relay UEs or relay UEs, a fifth identification information of the candidate relay UEs or relay UEs, a fifth cell identity information for the candidate relay UEs or relay UEs, and a response information for a remote UE configuration.

According to an implementation of the invention, the method further includes: transmitting a sixth message to the third node, wherein the sixth message includes information related to conditional path switch; and receiving a seventh message in response to the sixth message from the third node.

According to an implementation of the invention, the information related to conditional path switch includes at least one of the following information: a fourth information requesting or indicating path switch, a fourth information requesting or indicating conditional path switch, a fifth identification information of the candidate relay UEs or relay UEs, a fourth identification information of the remote UE, and a context setup or modification information for the relay UE.

According to an embodiment of the invention, the fourth information requesting or indicating conditional path switch includes at least one of the following information: a third conditional path switch request indication, a third conditional path switch initiation indication, a third conditional path switch replace indication, and a second conditional path switch cancel indication.

According to an implementation of the invention, the seventh message includes seventh related information of candidate relay UEs or relay UEs, and the seventh related information of the candidate relay UEs or relay UEs includes at least one of the following information: a third indication information for responding to or acknowledging of or confirming on providing a path switch configuration, a third indication information for responding to or acknowledging of or confirming on providing a conditional path switch configuration, a sixth identification information of the candidate relay UEs or relay UEs, a fifth identification information of the remote UE, and a response information for context setup or modification of the relay UE.

According to an implementation of the invention, the method further includes transmitting an eighth message to a fifth node, wherein the eighth message includes eighth related information of candidate relay UEs or relay UEs, wherein the eighth related information of the candidate relay UEs or relay UEs includes at least one of the following information: a fifth information requesting or indicating path switch, a fifth information requesting or indicating conditional path switch, a seventh identification information of the candidate relay UEs or relay UEs, a configuration/reconfiguration information or conditional configuration/reconfiguration information for the relay UE, and a sixth identification information of the remote UE.

According to an implementation of the invention, the method further includes: transmitting a ninth message to the first node, wherein the ninth message includes first related information of target relay UEs or relay UEs.

According to an implementation of the invention, the method further includes: receiving a tenth message from the first node, wherein the tenth message includes second related information of target relay UEs or relay UEs.

According to various embodiments of the invention, an information transmission method performed by a first node is provided, including: transmitting a first message to a second node, wherein the first message includes first related information of candidate relay UEs or relay UEs; receiving a second message in response to the first message from the second node; and transmitting a third message to a fourth node, wherein the third message includes third related information of candidate relay UEs or a relay UEs.

According to an implementation of the invention, the first related information of the candidate relay UEs or relay UEs includes at least one of the following information: a first information requesting or indicating path switch, a first information requesting or indicating conditional path switch, a first list of the candidate relay UEs or relay UEs, a first identification information of the candidate relay UEs or relay UEs, a first cell identity information for the candidate relay UEs or relay UEs, a measurement report for sidelink measurement results between the candidate relay UEs or relay UEs and a remote UE, and a first identification information of the remote UE.

According to an implementation of the invention, the first information requesting or indicating conditional path switch includes at least one of the following information: a first conditional path switch request indication, a first conditional path switch initiation indication, a first conditional path switch replace indication, a first estimated arrival probability, and a target NG-RAN (next generation radio access network) node UE (user equipment) XnAP (Xn application protocol) ID.

According to an implementation of the invention, the second message includes second related information of candidate relay UEs or relay UEs, and the second related information of the candidate relay UEs or relay UEs includes at least one of the following information: a first indication information for responding to or acknowledging of or confirming on providing a path switch configuration, a first indication information for responding to or acknowledging of or confirming on providing a conditional path switch configuration, a first number/maximum number of conditional path switch preparations, a second list of the candidate relay UEs or relay UEs, a second identification information of the candidate relay UEs or relay UEs, a second cell identity information for the candidate relay UEs or relay UEs, a first configuration information for the remote UE, and a second identification information of the remote UE.

According to an implementation of the invention, the second list of the candidate relay UEs or relay UEs is a subset of the first list of the candidate relay UEs or relay UEs.

According to an implementation of the invention, the first configuration information for the remote UE includes at least one of the following information: a first configuration information or addition/setup information or modification information of a PC5 radio link control RLC channel, a first configuration information or addition/setup information or modification information of a radio bearer, and a first configuration information or addition/setup information or modification information of a Sidelink Relay Adaptation Protocol SRAP.

According to an implementation of the invention, the second identification information of the remote UE includes at least one of the following information: a local ID of the remote UE, and a Layer-2 ID of the remote UE.

According to an implementation of the invention, the third related information of the candidate relay UEs or relay UEs includes at least one of the following information: a second information requesting or indicating path switch, a second information requesting or indicating conditional path switch, a third list of the candidate relay UEs or relay UEs, a third identification information of the candidate relay UEs or relay UEs, a third cell identity information for the candidate relay UEs or relay UEs, a second configuration/reconfiguration information or conditional configuration/reconfiguration information for a remote UE, and a third identification information of the remote UE.

According to an implementation of the invention, the method further includes: receiving a ninth message from the first node, wherein the ninth message includes first related information of target relay UEs or relay UEs.

According to an implementation of the invention, the method further includes: transmitting a tenth message to the second node, wherein the tenth message includes second related information of target relay UEs or relay UEs.

According to various embodiments of the invention, an information transmission method performed by a fourth node, including: receiving a third message from a first node, wherein the third message includes third related information of candidate relay UEs or relay UEs, wherein the third message is transmitted by the first node after transmitting a first message to a second node and receiving a second message in response to the first message from the second node, and wherein the first message includes first related information of candidate relay UEs or relay UEs.

According to an implementation of the invention, the third related information of the candidate relay UEs or relay UEs includes at least one of the following information: a second information requesting or indicating path switch, a second information requesting or indicating conditional path switch, a third list of the candidate relay UEs or relay UEs, a third identification information of the candidate relay UEs or relay UEs, a third cell identity information for the candidate relay UEs or relay UEs, a second configuration/reconfiguration information or conditional configuration/reconfiguration information for a remote UE, and a third identification information of the remote UE.

According to an implementation of the invention, the first related information of the candidate relay UEs or relay UEs includes at least one of the following information: a first information requesting or indicating path switch, a first information requesting or indicating conditional path switch, a first list of the candidate relay UEs or relay UEs, a first identification information of the candidate relay UEs or relay UEs, a first cell identity information for the candidate relay UEs or relay UEs, a measurement report for sidelink measurement results between the candidate relay UEs or relay UEs and a remote UE, and a first identification information of the remote UE.

According to an implementation of the invention, the second message includes second related information of a candidate relay UEs or relay UEs, and the second related information of the candidate relay UEs or relay UEs includes at least one of the following information: a first indication information for responding to or acknowledging of or confirming on providing a path switch configuration, a first indication information for responding to or acknowledging of or confirming on providing a conditional path switch configuration, a first number/maximum number of conditional path switch preparations, a second list of the candidate relay UEs or relay UEs, a second identification information of the candidate relay UEs or relay UEs, a second cell identity information for the candidate relay UEs or relay UEs, a first configuration information for the remote UE, and a second identification information of the remote UE.

According to an implementation of the invention, the method further includes: selecting a target relay UE; and performing conditional path switch based on the selection.

According to various embodiments of the present invention, a second node is provided, including: a transceiver configured to transmit and receive signals; and a controller coupled with the transceiver and configured to perform the aforementioned methods.

According to various embodiments of the present invention, a first node is provided, including: a transceiver configured to transmit and receive signals; and a controller coupled with the transceiver and configured to perform the aforementioned methods.

According to various embodiments of the present invention, a fourth node is provided, including: a transceiver configured to transmit and receive signals; and a controller coupled with the transceiver and configured to perform the aforementioned methods.

The invention can ensure the service continuity of the remote UE in more scenarios or ensure the enhancement to lossless delivery.

### Advantageous Effects of Invention

Advantages, and salient features of the invention will become apparent to those skilled in the art from the following detailed description, which, taken in conjunction with the annexed drawings, discloses exemplary embodiments of the invention.

According to various embodiments of the present disclosure, method and apparatus an information transmission method and equipment.

### BRIEF DESCRIPTION OF DRAWINGS

In order to illustrate the technical solution of embodiments of the present disclosure more clearly, the drawings of the embodiments will be briefly introduced below, and apparently, the drawings in the following description only relate to some embodiments of the present disclosure, but do not limit the present disclosure. In the drawings:

FIG. 1 is an exemplary system architecture of system architecture evolution (SAE);

FIG. 2 is an exemplary system architecture according to various embodiments of the present disclosure;

FIG. 3 is an example of a base station structure according to various embodiments of the present disclosure;

FIG. 4A illustrates examples of service continuity scenarios according to various embodiments of the present disclosure;

FIG. 4B illustrates examples of service continuity scenarios according to various embodiments of the present disclosure;

FIG. 4C illustrates examples of service continuity scenarios according to various embodiments of the present disclosure;

FIG. 4D illustrates examples of service continuity scenarios according to various embodiments of the present disclosure;

FIG. 5A illustrates examples of service continuity support according to various embodiments of the present disclosure;

FIG. 5B illustrates examples of service continuity support according to various embodiments of the present disclosure;

FIG. 5C illustrates examples of service continuity support according to various embodiments of the present disclosure;

FIG. 5D illustrates examples of service continuity support according to various embodiments of the present disclosure;

FIG. 5E illustrates examples of service continuity support according to various embodiments of the present disclosure;

FIG. 5F illustrates examples of service continuity support according to various embodiments of the present disclosure;

FIG. 6A illustrates examples of enhancements to ensure lossless delivery according to various embodiments of the present disclosure;

FIG. 6B illustrates examples of enhancements to ensure lossless delivery according to various embodiments of the present disclosure;

FIG. 6C illustrates examples of enhancements to ensure lossless delivery according to various embodiments of the present disclosure;

FIG. 6D illustrates examples of enhancements to ensure lossless delivery according to various embodiments of the present disclosure;

FIG. 6E illustrates examples of enhancements to ensure lossless delivery according to various embodiments of the present disclosure; and

FIG. 7 illustrates a block diagram of a configuration of a node according to various embodiments of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents. It is to be understood that the singular forms “a”, “an”, and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A” or “B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

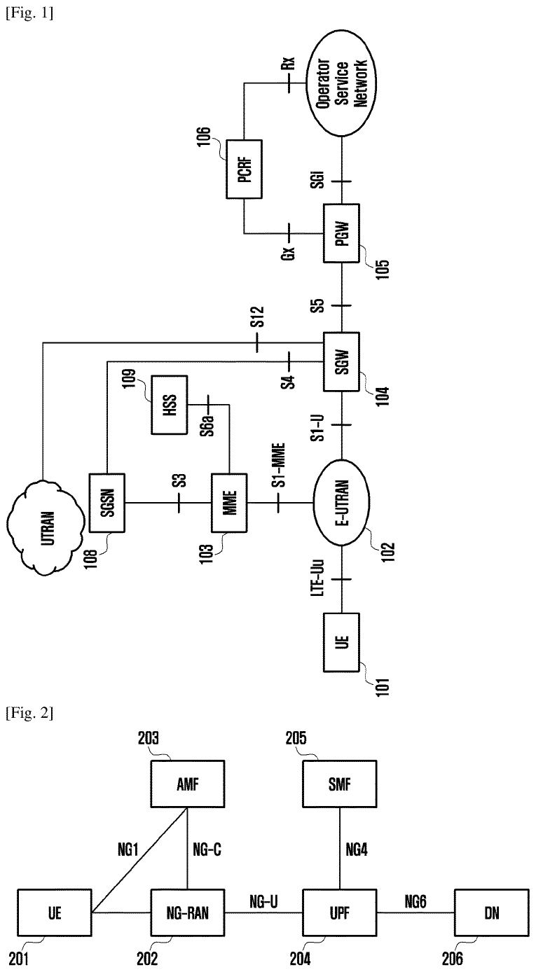

FIGS. 1 to 6 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

Throughout the specification, references to “one embodiment”, “an embodiment”, “one example” or “an example” mean that a specific feature, structure or characteristic described in connection with the embodiment or example is included in at least one embodiment of the present disclosure. Therefore, the phrases “in one embodiment” “in an embodiment”, “one example” or “an example” in various places throughout the specification do not necessarily all refer to the same embodiment or example. Furthermore, specific features, structures or characteristics may be combined in one or more embodiments or examples with any suitable combination and/or subcombination. Furthermore, it should be understood by those skilled in the art that the drawings provided herein are for illustration purposes and are not necessarily drawn to scale. The term “and/or” used herein includes any and all combinations of one or more related listed items.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

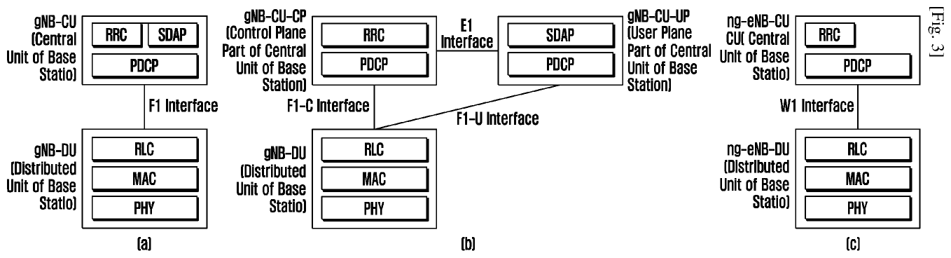

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties. An interface between the AMF and the NG-RAN is called an NG-C interface, or an NG interface or an N2 interface. An interface between the UPF and the NG-RAN is called an NG-U interface, or an N3 interface, and signaling between the UE and the AMF is called Non-Access Stratum (NAS) signaling, also called an N1 interface. An interface between base stations is called an Xn interface.

In NR systems, in order to support network function virtualization, more efficient resource management and scheduling, a base station (gNB/ng-eNB) that provides wireless network interfaces for a terminal (UE) may be further divided into a central unit gNB-CU/ng-eNB-CU (gNB central unit/ng-eNB central unit) and a distributed unit (gNB-DU/ng-eNB-DU) (abbreviated as CU and DU in the invention), as shown in FIG. 3(a). The gNB-CU has a radio resource control (RRC) layer, a service data adaptation protocol (SDAP) layer and a packet data convergence protocol (PDCP) protocol layer, and the ng-eNB-CU has an RRC layer and a PDCP layer. The gNBDU/ng-eNB-DU has a radio link control protocol (RLC) layer, a medium access control (MAC) layer, a physical layer and/or the like. There is a standardized public interface F1 between the gNB-CU and the gNB-DU, and there is a standardized public interface W1 between the ng-eNB-CU and the ng-eNB-DU. The F1 interface is divided into a control plane F1-C and a user plane F1-U. A transport network layer of the F1-C is based on IP transmission. In order to transmit signaling more reliably, an SCTP protocol is added to IP. The application layer protocol is F1AP. The SCTP can provide reliable transmission of application layer messages. A transport layer of the F1-U is UDP/IP, and a GTP-U is used to carry user plane protocol data units (PDUs) above UDP/IP. Furthermore, for the gNB-CU, as shown in FIG. 3(b), the gNB-CU can include a gNB-CU-CP (a control plane part of the central unit of the base station) and a gNB-CU-UP (a user plane part of the central unit of the base station). The gNBCU-CP includes functions of the control plane of the base station and has an RRC protocol layer and a SDAP protocol layer, while the gNB-CU-UP includes the control plane part of the base station. There is a standardized public interface E1 between gNB-CU-CP and gNB-CU-UP, and the protocol is E1AP. An interface between the control plane part of the central unit of the base station and the distributed unit of the base station is an F1-C interface, that is, the control plane interface of F1, and an interface between the user plane part of the central unit of the base station and the distributed unit of the base station is an F1-U interface, that is, a user plane interface of F1. In addition, in NR systems, the base station that provides an E-UTRA user plane and control plane for accessing the 5G core network is called ng-eNB. In order to support virtualization, such base station (ng-eNB) may also be further divided into a central unit ng-eNB-CU (gNB central unit/ng-eNB central unit) and a distributed unit ng-eNB-DU (gNB distributed unit/ng-eNB distributed unit) (abbreviated as CU and DU in the invention), as shown in FIG. 3(c). The ng-eNB-CU has an RRC layer and a PDCP layer. The gNB-DU/ng-eNB-DU has a radio link control protocol (RLC) layer, a medium access control (MAC) layer, a physical layer and/or the like. There is a standardized public interface W1 between the ng-eNB-CU and the ng-eNB-DU. The W1 interface is divided into a control plane W1-C and a user plane W1-U. a transport network layer of the W1-C is based on IP transmission. In order to transmit signaling more reliably, an SCTP protocol is added to IP. The application layer protocol is W1AP. A transport layer of the W1-U is UDP/IP, and a GTP-U is used to carry user plane protocol data units (PDUs) above UDP/IP.

With the gradual maturity of 5G commercial networks (e.g., New Radio (NR) networks), the application scope of NR Sidelink Relay technology is also expanded. In order to better support the service continuity of UEs, the corresponding research and standardization work has also been started.

At present, an inter-base station path switch scenario has not been researched for 5G Sidelink Relay, nor for an indirect-to-indirect path switch scenario. In addition, at present, how to ensure lossless delivery of data during the path switch process has not been studied for the 5G Sidelink Relay.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

Before introducing the specific content, some assumptions and definitions of the invention are given below.
The message names in the invention are only examples, and other message names may also be used.
The “first”, “second” and/or the like included in the message names of the invention are only examples of messages, and do not represent the order of execution.
In the invention, detailed description of steps irrelevant to the invention is omitted.
In the invention, the steps in each procedure may be performed in combination with each other or independently performed. The execution steps of each procedure are only examples, and other possible execution orders are not excluded.
In the invention, the base station may be a 5G base station (such as gNB, ng-eNB), a 4G base station (such as eNB), a 6G base station, or other types of access nodes.
In the invention, transmission of data refers to receiving or transmitting of the data.

The nodes involved in the invention are:
first node: a source base station, or a central unit of the source base station (e.g., SgNB-CU), or a control plane part of the central unit of the source base station, or a user plane part of the central unit of the source base station
second node: a target base station, or a central unit of the target base station (e.g., T-gNB-CU), or a control plane part of the central unit of the target base station, or a user plane part of the central unit of the target base station
third node: a distributed unit of the (source or target) base station (e.g. S-gNB-DU or T-gNB-DU)
fourth node: a remote UE
fifth node: a Relay UE
sixth node: a control plane part of a central unit of a source base station
seventh node: a user plane part of a central unit of a source base station

It should be pointed out that when the first node is the central unit of the source base station, the first node includes the sixth node and the seventh node.

In order to solve at least one of the above problems, the present invention provides a method for supporting service continuity, which ensures the service continuity of the remote UE in more scenarios.

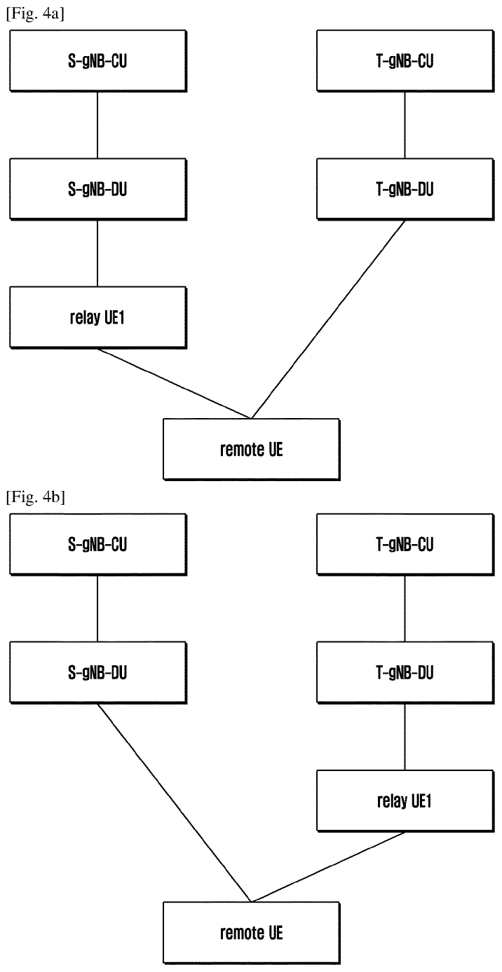

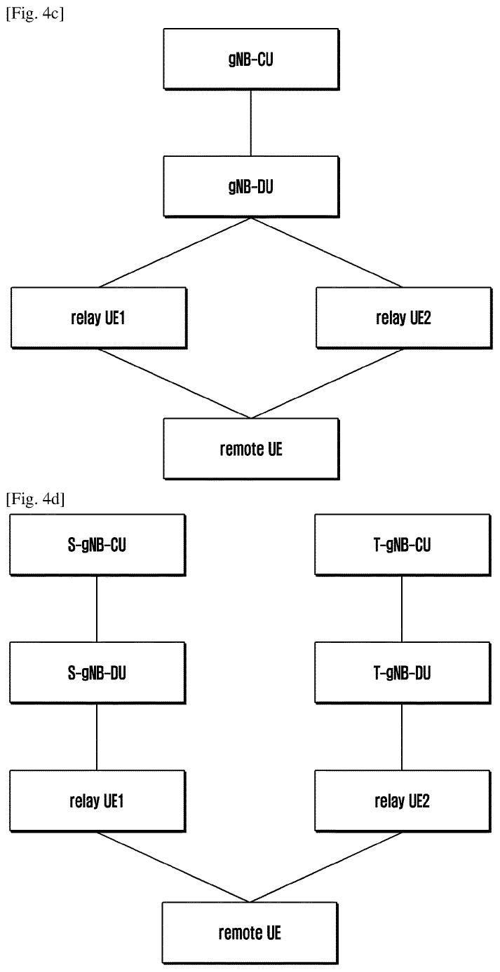

Specifically, some typical scenarios of the above more supported scenarios are shown in FIGS. 4A, 4B, 4C, 4D:

FIG. 4A illustrates an indirect-to-direct path switch scenario for inter-base station.

FIG. 4B illustrates a direct-to-indirect path switch scenario for inter-base station.

FIG. 4C illustrates an indirect-to-indirect path switch scenario for intra-base station.

FIG. 4D illustrates an indirect-to-indirect path switch scenario for inter-base station.

It should be noted that FIGS. 4A, 4B, 4C, 4D only describe some typical scenarios of service continuity support. For the service continuity support schemes to be described below, the scenarios that can be solved include but are not limited to the typical scenarios shown in FIGS. 4A, 4B, 4C, 4D.

The service continuity support schemes of the invention include the following processes:

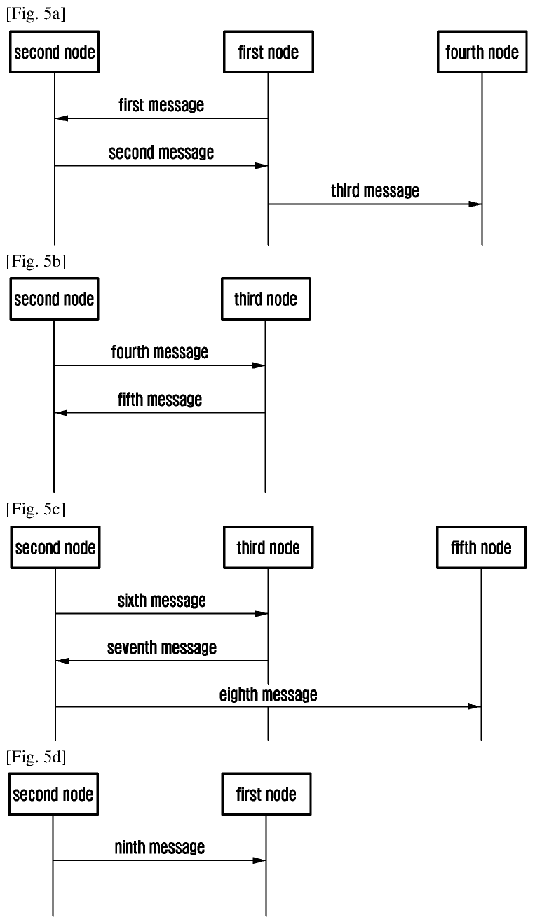

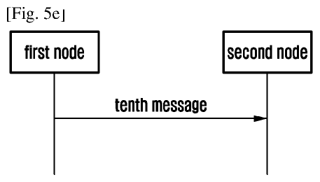

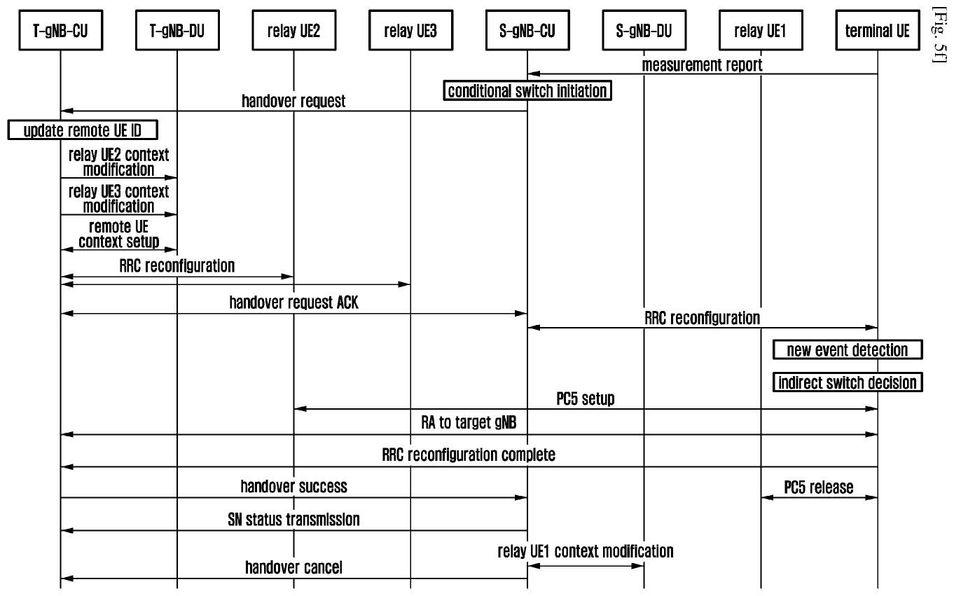

As shown in FIG. 5A, a first node triggers a path switch process, and alternatively, the first node may trigger a conditional path switch (or conditional switch, which may be described as conditional switch in the following description for simplicity) process; or alternatively, a second node may also trigger the conditional path switch process.

The first node provides path switch related information to the second node. The path switch related information may be included in a first message. The path switch related information includes at least one of the following information:
first information requesting or indicating path switch
first information requesting or indicating conditional path switch
first list of candidate relay UEs/relay UEs
first identification information of candidate relay UEs/relay UEs
first cell identity information for candidate relay UEs/relay UEs
measurement results or measurement report information for sidelink measurement results (or direct links, which are described using sidelink in the following specification) between candidate relay UEs/relay UEs and remote UE
first identification information of remote UE

Specifically, the first information requesting or indicating conditional path switch includes at least one of the following information:
first conditional path switch request indication
first conditional path switch initiation indication
first conditional path switch replace indication
target NG-RAN node UE XnAP (Xn application protocol) ID if a first conditional path switch replace request indication exists
first estimated arrival probability. It should be noted that the first estimated arrival probability may be a probability that a remote UE is connected to a target cell through a certain candidate relay UE/relay UE, or a probability that the remote UE is connected to a certain candidate target cell.

Specifically, the measurement results or measurement report information of the sidelinks between the candidate relay UEs/relay UEs and the remote UE includes at least one of the following information:
sidelink reference signal received power (RSRP)
sidelink reference signal received quality (RSRQ)
sidelink signal to interference plus noise ratio (SINR)
sidelink discovery reference signal received power (SD-RSRP)
sidelink discovery reference signal received quality (SD-RSRQ)
sidelink discovery signal to interference plus noise ratio (SD-SINR)

Specifically, the first identification information of the remote UE includes at least one of the following information:
first local ID of remote UE
first Layer-2 ID of remote UE

The first message may be a HANDOVER REQUEST message of an Xn interface, a HandoverPreparationInformation message for inter-node RRC, other existing or newly defined Xn or inter-node RRC messages, or a combination of the above messages.

The second node transmits a first response or acknowledge information to the first node after receiving the path switch related information from the first node, and alternatively, the second node updates the first identification information of the remote UE. The first response or acknowledge information may be included in a second message, and the first response or acknowledge information includes at least one of the following information:
first indication information for responding to or acknowledging of or confirming on providing path switch configuration
first indication information for responding to or acknowledging of or confirming on providing conditional path switch configuration
first number/maximum number of conditional path switch preparations
second list of candidate relay UEs/relay UEs
second identification information of candidate relay UEs/relay UEs
second cell identity information for candidate relay UEs/relay UEs
first configuration information for remote UE
second identification information of remote UE

Specifically, the first configuration information for the remote UE includes at least one of the following information:
first configuration/addition/modification information of PC5 radio link control (RLC) channel
first configuration/addition/modification information of radio bearer
first configuration/addition/modification information of SRAP (Sidelink Relay Adaptation Protocol).

Specifically, the second identification information of the remote UE includes at least one of the following information:
second local ID of remote UE
second Layer-2 ID of remote UE

It should be noted that the second list of candidate relay UEs/relay UEs in the first response or acknowledge information may be a subset of the first list of candidate relay UEs/relay UEs in the path switch related information described above.

The second message may be a HANDOVER REQUEST ACKNOWLEDGE message of an Xn interface, a HandoverCommand message for inter-node RRC, other existing or newly defined Xn or inter-node RRC messages, or a combination of the above messages.

The first node transmits first reconfiguration information to a fourth node after receiving the first response or acknowledge information from the second node, where the first reconfiguration information may be included in a third message, for example, in an RRCReconfiguration message, and other existing or new RRC messages. The first reconfiguration information includes at least one of the following information:
second information requesting or indicating path switch
second information requesting or indicating conditional path switch
third list of candidate relay UEs/relay UEs
third identification information of candidate relay UEs/relay UEs
third cell identity information for candidate relay UEs/relay UEs
second configuration/reconfiguration information or conditional configuration/reconfiguration information for remote UE
third identification information of remote UE

Specifically, the second configuration/reconfiguration information or conditional configuration/reconfiguration information for the remote UE includes at least one of the following information:
second configuration/addition/modification information of PC5 RLC channel
second configuration/addition/modification information of radio bearer
second configuration/addition/modification information of SRAP (Sidelink Relay Adaptation Protocol)

Specifically, the third identification information of the remote UE includes at least one of the following information:
third local ID of remote UE
third Layer-2 ID of remote UE

The fourth node receives the first reconfiguration message, where the first reconfiguration message at least includes a condition for performing conditional path switch. After satisfying the condition, the fourth node selects a target relay UE and performs the conditional path switch based on the selection.

As shown in FIG. 5B, the second node transmits first UE context setup/modification request information to the third node. The first UE context setup/modification request information may be included in a fourth message. The first UE context setup/modification request information includes at least one of the following information:
third information requesting or indicating path switch
third information requesting or indicating conditional path switch
fourth list of candidate relay UEs/relay UEs
fourth identification information of candidate relay UEs/relay UEs
fourth cell identity information for candidate relay UEs/relay UEs
third configuration information for remote UE. It should be noted that the third configuration information for the remote UE may be configuration information for a certain candidate relay UE/relay UE or a configuration information list corresponding to the list of candidate relay UEs/relay UEs.

Specifically, the third information requesting or indicating conditional path switch includes at least one of the following information:
second conditional path switch request indication
second conditional path switch initiation indication
second conditional path switch replace indication
first conditional path switch cancel indication
target gNB-DU UE F1AP ID if the second conditional path switch replace indication exists
identification information of candidate relay UEs/relay UEs and/or identification information of cells to be cancelled if the first conditional path switch cancel indication exists
second estimated arrival probability. It should be noted that the second estimated arrival probability may be a probability that a remote UE is connected to a target cell through a certain candidate relay UE/relay UE, or a probability that the remote UE is connected to a certain candidate target cell.

Specifically, the third configuration information for the remote UE includes at least one of the following information:
first setup/modification/release information of PC5 RLC channel, which may include QoS information corresponding to the PC5 RLC channel
first setup/modification/release information of radio bearer, which may include QoS information corresponding to the radio bearer

The fourth message may be a UE CONTEXT SETUP REQUEST message of an F1 interface, a UE CONTEXT MODIFICATION REQUEST message of the F1 interface, or other existing or newly defined F1 interface messages.

The third node transmits a second response or acknowledge information to the second node after receiving the first UE context setup/modification request information from the second node, where the second response or acknowledge information may be included in a fifth message, and the second response or acknowledge information includes at least one of the following information:
second indication information for responding to or acknowledging of or confirming on providing path switch configuration
second indication information for responding to or acknowledging of or confirming on providing conditional path switch configuration
second number/maximum number of conditional path switch preparations
fifth list of candidate relay UEs/relay UEs
fifth identification information of candidate relay UEs/relay UEs
fifth cell identity information for candidate relay UEs/relay UEs
response information for remote UE configuration. It should be noted that the response information for remote UE configuration may be response information for a certain candidate relay UE/relay UE configuration, or a response information list of a configuration corresponding to the list of candidate relay UEs/relay UEs.

Specifically, the response information for remote UE configuration includes at least one of the following information:
first response information for PC5 RLC channel setup/setup failure/modification/modification failure
first response information for radio bearer setup/setup failure/modification/modification failure

It should be noted that the fifth list of candidate relay UEs/relay UEs in the second response or acknowledge information may be a subset of the fourth list of candidate relay UEs/relay UEs in the first UE context setup/modification request information described above.

The fifth message may be a UE CONTEXT SETUP RESPONSE message of an F1 interface, a UE CONTEXT MODIFICATION RESPONSE message of the F1 interface, or other existing or newly defined F1 interface messages.

As shown in FIG. 5C, the second node transmits second UE context setup/modification request information to the third node. The second UE context setup/modification request information may be included in a sixth message. The second UE context setup/modification request information includes at least one of the following information:
fourth information requesting or indicating path switch
fourth information requesting or indicating conditional path switch
fifth identification information of candidate relay UEs/relay UEs
fourth identification information of remote UE
context setup/modification information for relay UE

Specifically, the fourth information requesting or indicating conditional path switch includes at least one of the following information:
third conditional path switch request indication
third conditional path switch initiation indication
third conditional path switch replace indication
second conditional path switch cancel indication

Specifically, the fourth identification information of the remote UE includes at least one of the following information:
fourth local ID of remote UE
fourth Layer-2 ID of remote UE

Specifically, the context setup/modification information for the relay UE includes at least one of the following information:
setup/modification/release information of Uu RLC Channel, which may include QoS information corresponding to the Uu RLC channel
second setup/modification/release information of PC5 RLC channel, which may include QoS information corresponding to the PC5 RLC channel
second setup/modification/release information of radio bearer, which may include QoS information corresponding to the radio bearer

The sixth message may be a UE CONTEXT SETUP REQUEST message of an F1 interface, a UE CONTEXT MODIFICATION REQUEST message of the F1 interface, or other existing or newly defined F1 interface messages.

The third node transmits a third response or acknowledge information to the second node after receiving the second UE context setup/modification request information from the second node, where the third response or acknowledge information may be included in a seventh message, and the third response or acknowledge information includes at least one of the following information:
third indication information for responding to or acknowledging of or confirming on providing path switch configuration
third indication information for responding to or acknowledging of or confirming on providing conditional path switch configuration
sixth identification information of candidate relay UEs/relay UEs
fifth identification information of remote UE
response information for context setup/modification of relay UE

Specifically, the fifth identification information of the remote UE includes at least one of the following information:
fifth local ID of remote UE
fifth Layer-2 ID of remote UE

Specifically, the response information for context setup/modification of the relay UE includes at least one of the following information:
response information for Uu RLC channel setup/setup failure/modification/modification failure
second response information for PC5 RLC channel setup/setup failure/modification/modification failure
second response information for radio bearer setup/setup failure/modification/modification failure

The seventh message may be a UE CONTEXT SETUP RESPONSE message of an F1 interface, a UE CONTEXT MODIFICATION RESPONSE message of the F1 interface, or other existing or newly defined F1 interface messages.

The second node transmits second reconfiguration information to a fifth node after receiving the third response or acknowledge information from the third node, where the second reconfiguration information may be included in an eighth message, for example, in an RRCReconfiguration message, and other existing or new RRC messages. The second reconfiguration information includes at least one of the following information:
fifth information requesting or indicating path switch
fifth information requesting or indicating conditional path switch
seventh identification information of candidate relay UEs/relay UEs
configuration/reconfiguration information or conditional configuration/reconfiguration information for relay UE
sixth identification information of remote UE

Specifically, the configuration/reconfiguration information or conditional configuration/reconfiguration information for the relay UE includes at least one of the following information:
configuration/addition/modification information of Uu RLC Channel
third configuration/addition/modification information of PC5 RLC channel
third configuration/addition/modification information of radio bearer
third configuration/addition/modification information of SRAP (Sidelink Relay Adaptation Protocol)

Specifically, the sixth identification information of the remote UE includes at least one of the following information:
sixth local ID of remote UE
sixth Layer-2 ID of remote UE

As shown in FIG. 5D, the second node transmits conditional path switch success information to the first node. The conditional path switch success information may be included in a ninth message. The conditional path switch success information includes at least one of the following information:
first identification information of target candidate relay UEs/relay UEs
first target cell identification information (or described as first cell identity information for target candidate relay UEs/relay UEs)
seventh identification information of remote UE

Specifically, the seventh identification information of the remote UE includes at least one of the following information:
seventh local ID of remote UE
seventh Layer-2 ID of remote UE

The ninth message may be a HANDOVER SUCCESS message of an Xn interface or other existing or newly defined Xn interface messages.

As shown in FIG. 5E, the first node transmits conditional path switch cancel information to the second node. The conditional path switch cancel information may be included in a tenth message. The conditional path switch cancel information includes at least one of the following information:
list of target candidate relay UEs/relay UEs
second identification information of target candidate relay UEs/relay UEs
second target cell identification information (or described as second cell identity information for target candidate relay UEs/relay UEs)
eighth identification information of remote UE

Specifically, the eighth identification information of the remote UE includes at least one of the following information:
eighth local ID of remote UE
eighth Layer-2 ID of remote UE

The tenth message may be a HANDOVER CANCEL message of an Xn interface, a CONDITIONAL HANDOVER CANCEL message, or other existing or newly defined Xn interface messages.

In addition, according to various embodiments of the present disclosure, one or more of the above processes may also refer to FIG. 5F.

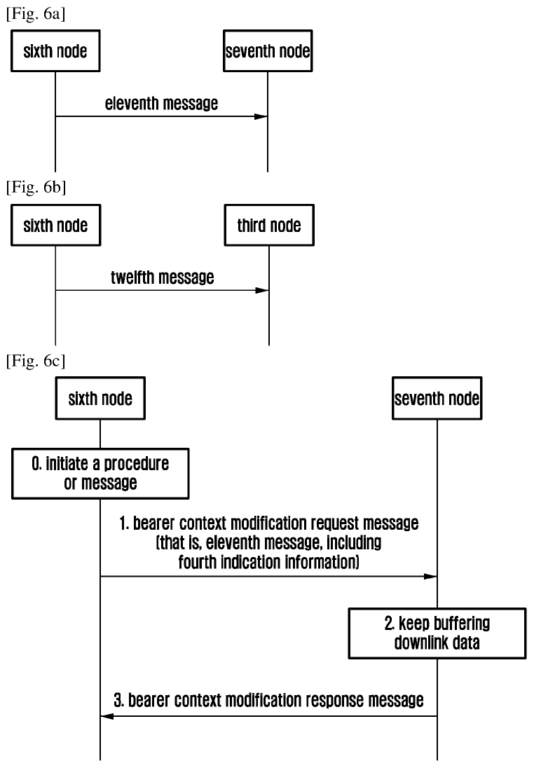

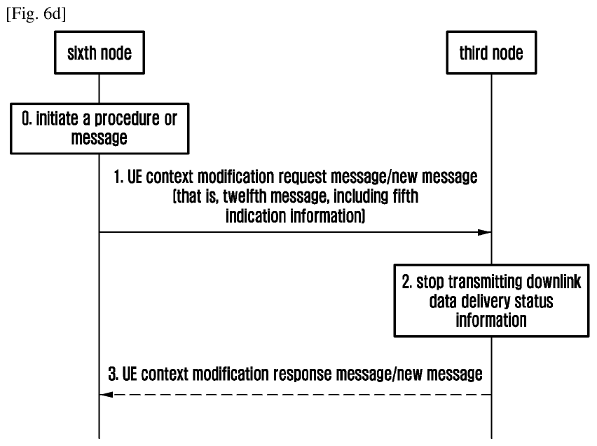

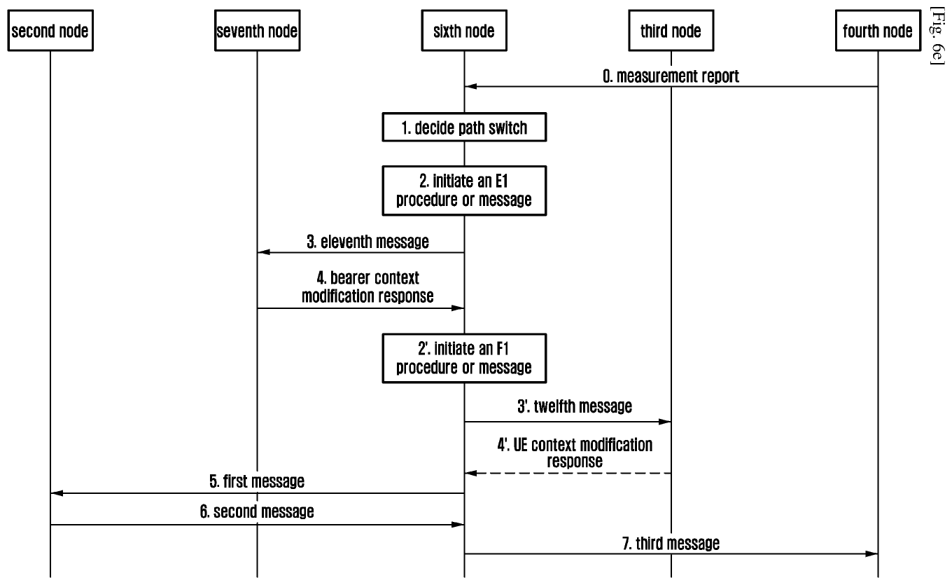

In order to support service continuity in a path switch process, it is necessary to ensure lossless delivery of data in the path switch process. However, the existing transmission mechanism cannot ensure the lossless delivery of data in the path switch process. FIGS. 6A, 6B, 6C, 6D, 6E illustrate examples of enhancements to ensure lossless delivery. Through the embodiment, the nodes can be ensured to cache/buffer the necessary data through the way of inter-node indication, so as to ensure that a receiving node can receive all the unreceived data after path switch, and realize the lossless delivery of data.

The enhancement scheme for ensuring lossless delivery of the invention includes the following processes:

As shown in FIG. 6A, a sixth node transmits/sends fourth indication information to a seventh node. The fourth indication information may be included in an eleventh message. The fourth indication information includes at least one of the following information:
related indication for path switch
related indication to maintain/keep caching/buffering
related indication to stop discarding data
related indication to ignore some or all of downlink data delivery status information

The eleventh message may be a BEARER CONTEXT MODIFICATION REQUEST message of an E1 interface, or other existing or newly defined E1 interface messages.

As shown in FIG. 6B, a sixth node transmits/sends a fifth indication information to a third node. The fifth indication information may be included in a twelfth message. The fifth indication information includes at least one of the following information:
related indication for path switch
related indication to maintain/keep caching/buffering
related indication to stop discarding data
related indication to stop transmitting/sending downlink data delivery status information

The eleventh message may be a UE CONTEXT MODIFICATION REQUEST message of an F1 interface, or other existing or newly defined F1 interface messages.

As shown in FIG. 6C, an enhancement process of ensuring lossless delivery is illustrated.
Step 0: a sixth node triggers/initiates an interface procedure or triggers/initiates an interface message;
Step 1: the sixth node transmits/sends a bearer context modification request message including the fourth indication information to a seventh node;
Step 2: the seventh node maintains/keeps caching/buffering downlink data, or stops discarding the downlink data, or maintains/keeps caching/buffering the downlink data even if downlink data delivery status information indicates that the downlink data has been successfully delivered, or stops discarding the downlink data even if the downlink data delivery status information indicates that the downlink data has been successfully delivered according to content in an eleventh message;
Step 3: the seventh node transmits/sends a bearer context modification response message to the sixth node.

As shown in FIG. 6D, an enhancement process of ensuring lossless delivery is illustrated.
Step 0: a sixth node triggers/initiates an interface procedure or triggers/initiates an interface message;
Step 1: the sixth node transmits/sends a UE context modification request message or a new message including the fifth indication information to a third node;
Step 2: the third node stops transmitting/sending downlink data delivery status information according to content in a twelfth message;
Step 3: if the UE context modification request message is transmitted/sent in step 1, the third node transmits/sends a UE context modification response message or a UE context modification failure message to the sixth node in this step; if the new message is transmitted/sent in step 1, the third node transmits/sends a response message or an acknowledgement message or a failure message or a rejection message for the new message in step 1 to the sixth node in this step; or step 3 is not required.

As shown in FIG. 6E, an enhancement process of ensuring lossless delivery under service continuity is illustrated.
Step 0: a fourth node transmits/sends a measurement report to a sixth node;
Step 1: the sixth node determines/decides path switch;
Step 2: the sixth node triggers/initiates an E1 procedure or message;
Step 3: the sixth node transmits/sends the eleventh message to a seventh node;
Step 4: after receiving the eleventh message, the seventh node transmits/sends a bearer context modification response message;
Step 2′: the sixth node triggers/initiates an F1 procedure or message;
Step 3′: the sixth node transmits/sends the twelfth message to a third node;
Step 4′: after receiving the twelfth message, the third node transmits/sends a UE context modification response message;
Step 5: the sixth node transmits/sends the first message to a second node;
Step 6: the second node transmits/sends the second message to the sixth node;
Step 7: the sixth node transmits/sends the third message to the fourth node.

It should be noted that steps 2-4 and steps 2′-4′ may not exist at the same time (that is, one of two may be selected).

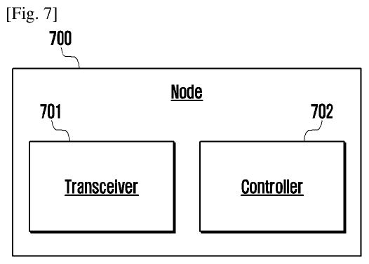

FIG. 7 illustrates a block diagram of a configuration of a node 700 according to various embodiments of the present disclosure. The node 700 may include any node herein.

Referring to FIG. 7, a node 700 according to various embodiments of the present disclosure may include a transceiver 701 and a controller 702. For example, the transceiver 701 may be configured to transmit and receive signals. For example, the controller 702 may be coupled to the transceiver 701 and configured to perform the aforementioned methods.

While the nodes are illustrated as having separate functional blocks for convenience of explanation, the configurations of the nodes are not limited thereto. For example, the nodes may include communication units consisting of transceivers and controllers. The nodes may communicate with at least one network node by means of the communication units.

According to embodiments of the present disclosure, at least part of the nodes (e.g., modules or functions thereof) or the methods (e.g., operations) may be implemented by instructions which are stored in a computer-readable storage medium (e.g., the memory) in a form of a program module. When executed by a processor or controller, the instructions may enable the processor or controller to perform corresponding functions. The computer-readable medium may include, for example, a hard disk, a floppy disk, a magnetic media, an optical recording media, a DVD, a magneto-optical media, and the like. The instructions may include codes made by a compiler or codes which can be executed by an interpreter. The nodes according to various embodiments of the present disclosure may include at least one or more of the aforementioned components, omit some of the aforementioned components, or further include other additional components. Operations executed by the modules, program modules, or other components according to various embodiments of the present disclosure may be executed sequentially, parallelly, repeatedly, or heuristically. Alternatively, at least some operations may be executed in different orders or may be omitted, or other operations may be added.

What has been described above are only example embodiments of the present invention, and are not intended to limit the scope of protection of the present invention, which is determined by the appended claims.

1-14. (canceled)

15. A method performed by a control plane (CP) part of a central unit (CU), comprising:
transmitting, to a user plane (UP) part of the CU, a first message; and
receiving, from the UP part of the CU, a response message in response to the first message,
wherein the first message includes an indication information, and
wherein the indication information includes an indication associated with discarding data.

16. The method of claim 15,
wherein the first message includes a bearer context modification request message, and
wherein the response message includes a bearer context modification response message.

17. The method of claim 15, wherein the data is not discarded based on downlink data delivery status information.

18. The method of claim 17, wherein the data is not discarded if the downlink data delivery status information indicates that the data has been successfully delivered.

19. A method performed by a user plane (UP) part of a central unit (CU), comprising:
receiving, from a control plane (CP) part of the CU, a first message from a control plane part of the CU; and
transmitting, to the CP part of the CU, a response message in response to the first message,
wherein the first message includes an indication information, and
wherein the indication information includes an indication associated with discarding data.

20. The method of claim 19,
wherein the first message includes a bearer context modification request message, and
wherein the response message includes a bearer context modification response message.

21. The method of claim 19, further comprising:
not discarding the data based on downlink data delivery status information.

22. The method of claim 21, further comprising:
not discarding the data even if the downlink data delivery status information indicates that the downlink data has been successfully delivered.

23. A control plane (CP) part of a central unit (CU) comprising:
a transceiver; and
a controller configured to:
transmit, to a user plane (UP) part of the CU, a first message, and
receive, from the UP part of the CU, a response message in response to the first message,
wherein the first message includes an indication information, and
wherein the indication information includes at an indication associated with discarding data.

24. The CP part of the CU of claim 23,
wherein the first message includes a bearer context modification request message, and
wherein the response message includes a bearer context modification response message.

25. The CP part of the CU of claim 23, wherein the data is not discarded based on downlink data delivery status information.

26. The CP part of the CU of claim 25, wherein the data is not discarded if the downlink data delivery status information indicates that the data has been successfully delivered.

27. A user plane part (UP) of a central unit (CU) comprising:
a transceiver; and
a controller configured to:
receive, from a control plane (CP) part of the CU, a first message, and
transmit, to the CP part of the CU, a response message in response to the first message,
wherein the first message includes an indication information, and wherein the indication information includes an indication associated with discarding data.

28. The UP part of the CU of claim 27,
wherein the first message includes a bearer context modification request message, and
wherein the response message includes a bearer context modification response message.

29. The UP part of the CU of claim 27, wherein the controller is further configured to:
not discard the data based on downlink data delivery status information; and
not discard the data even if the downlink data delivery status information indicates that the data has been successfully delivered.
